(19) United States
(12) Patent Application Publication
(10) Pub. No.: US 2014/0313601 A1
(43) Pub. Date: Oct. 23, 2014

(54) OPTICAL DEVICE AND DISPLAY SYSTEM

(71) Applicant: KABUSHIKI KAISHA TOSHIBA, Tokyo (JP)

(72) Inventors: Yoshiharu Momonoi, Yokohama-shi (JP); Tatsuo Saishu, Tokyo (JP)

(73) Assignee: KABUSHIKI KAISHA TOSHIBA, Tokyo (JP)

(21) Appl. No.: 14/067,540

(22) Filed: Oct. 30, 2013

(30) Foreign Application Priority Data
Apr. 22, 2013 (JP) 2013-89716

(51) Int. Cl. G02B 3/00

(52) U.S. Cl. CPC G02B 3/0006
USPC 359/741

(57) ABSTRACT

According to one embodiment, an optical device for a display apparatus is provided. The display apparatus include a display surface having a pixel area composed of a plurality of pixels, and a frame area that surrounds the pixel area. The optical device includes a lens array facing a plurality of pixels adjacent to at least a part of the frame area; and a lens facing at least a part of the frame area and a plurality of pixels adjacent to the lens array.

### CROSS REFERENCE TO RELATED APPLICATIONS

This application is based upon and claims the benefit of priority from the prior Japanese Patent Application No. 2013-89716, filed on Apr. 22, 2013, the entire contents of which are incorporated herein by reference.

### FIELD

Embodiments described herein relate generally to an optical device and a display system.

### BACKGROUND

A normal display is provided with a frame area around a display area. Since no image is displayed on the frame area, the frame area may damage the sense of presence. Therefore, it is desirable to make the frame area difficult to be seen by a viewer without causing distortion or the like in an image displayed on the display.

### BRIEF DESCRIPTION OF THE DRAWINGS

FIG. 1 is a front view of a display system 100 according to one embodiment.

FIG. 2 is a cross-sectional view taken along a line A-A′ in FIG. 1.

FIG. 3 is a diagram for explaining a design manner of the optical device 20.

FIG. 4 is a flowchart showing an example of a design procedure of the optical device 20.

FIG. 5 is a diagram for explaining the viewing area in the case in which the optical device 20 is designed by the design procedure shown in FIG. 4.

FIG. 6 is a diagram for explaining that light beams are directed to a viewer V located at a distance B away from the display surface 10.

FIGS. 7A and 7B are diagrams schematically showing a cross-sectional shape of each optical device 20.

FIG. 8 is a front view of a display system 100′ that performs autostereoscopic display.

FIGS. 9A to 9C are diagrams schematically showing a cross-sectional shape of each optical device 20 and 20′.

FIG. 10 is a schematic block diagram showing an entire configuration of the display system 100.

FIG. 11 is a front view of a display system obtained by tiling a plurality of display apparatus 200.

### DETAILED DESCRIPTION

In general, according to one embodiment, an optical device for a display apparatus is provided. The display apparatus include a display surface having a pixel area composed of a plurality of pixels, and a frame area that surrounds the pixel area. The optical device includes a lens array facing a plurality of pixels adjacent to at least a part of the frame area; and a lens facing at least a part of the frame area and a plurality of pixels adjacent to the lens array.

Hereinafter, the embodiment will be described with reference to the drawings.

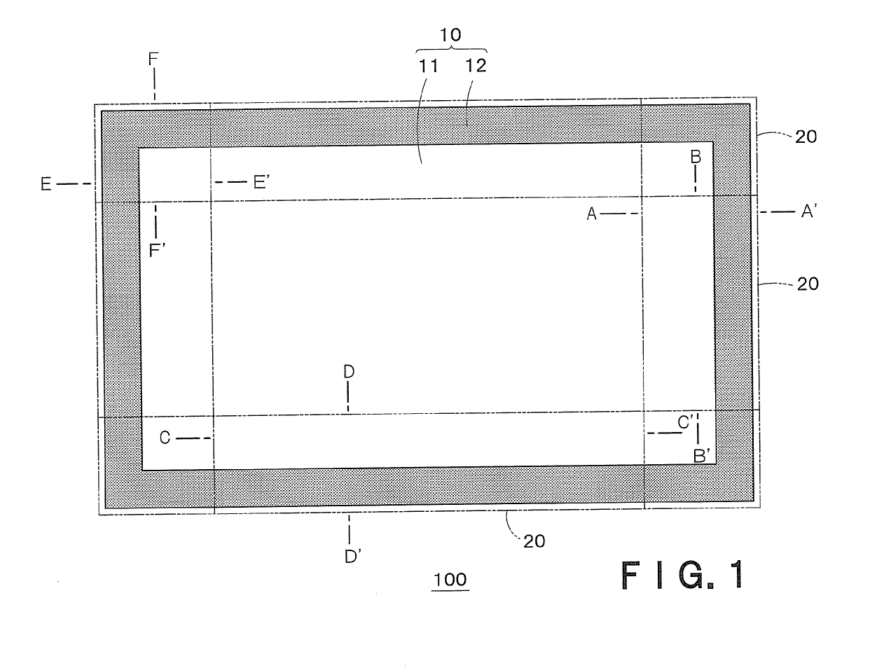

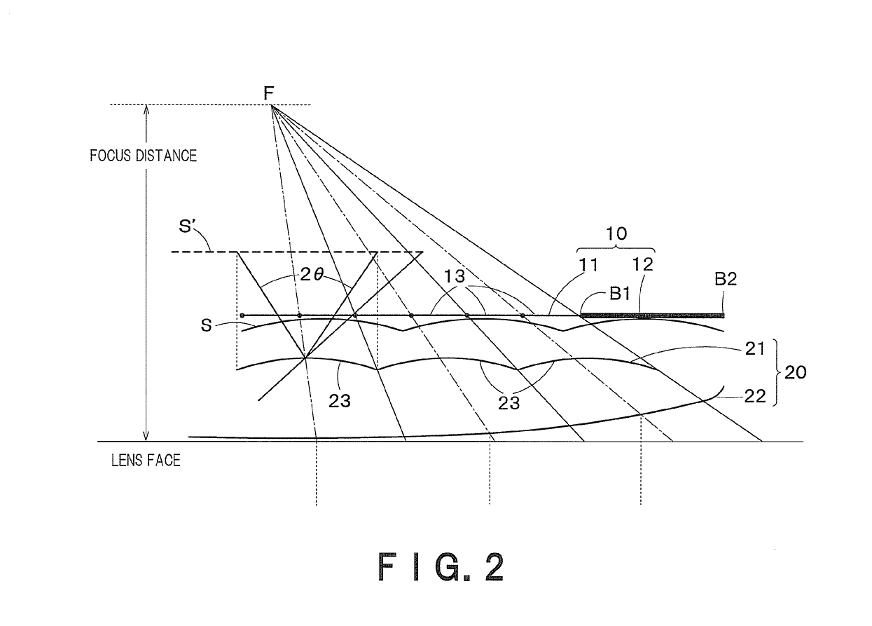

FIG. 1 is a front view of a display system 100 according to one embodiment. FIG. 2 is a cross-sectional view taken along a line A-A′ in FIG. 1. An overview of the present embodiment will be described with reference to FIGS. 1 and 2.

The display system 100 includes a display surface 10 and an optical device 20. The display surface 10 includes a pixel area 11 and a frame area 12. The optical device 20 includes at least two layers of lenses, that is, a lens array 21 and a lens 22 (not shown in FIG. 1). The optical device 20 is arranged to face a part of the display surface 10. A viewer observes the pixel area 11 through the optical device 20 in an area in which the optical device 20 is arranged and the viewer directly observes the pixel area 11 in an area in which the optical device 20 is not arranged.

In the present embodiment, also in the area in which the optical device 20 is arranged, the pixel area 11 is seen on the display surface 10 instead of on the optical device 20. Thereby, an image surface of the area in which the optical device 20 is arranged and an image surface of the area in which the optical device 20 is not arranged are prevented from being shifted from each other, so that a high quality image can be displayed.

In FIG. 1, an example is shown in which the optical devices 20 are arranged on the four sides and the four corners of the frame area 12. However, the optical devices 20 may be arranged on at least a part of the above portions.

The pixel area 11 is a display area which is formed of a plurality of pixels 13 arranged in a matrix form and in which an image is displayed. Each pixel 13 is formed by, for example, sub-pixels R, G, and B. The frame area 12 is also referred to as a bezel and provided so as to surround the four sides of the pixel area 11. The frame area 12 is a non-display area in which no image is displayed. The pixel area 11 and the frame area 12 are arranged on substantially the same plane and form the display surface 10.

The lens array 21 includes a plurality of microlenses 23. The lens array 21 is provided to face a plurality of pixels 13 adjacent to at least a part of the frame area 12. As described later, the lens array 21 and the lens 22 are provided so that an image surface S of exit pupil of the lens array 21 is formed substantially on the display surface 10 by the lens 22 and the pixel area 11 is observed but the frame area 12 is not observed through the lens 22.

Each microlens 23 of the lens array 21 corresponds to one or a plurality of pixels 13. In the description below, as shown in FIG. 2, an example in which one microlens 23 corresponds to two pixels 13 will be described. In this case, the pitch of the microlenses 23 is somewhat greater than the pitch of pairs of pixels. Therefore, the lens array 21 also faces a part of the frame area 12.

The lens 22 is provided to face the frame area 12 and the lens array 21. In other words, the lens 22 covers the frame area 12 and the lens array 21. The lens 22 may be a curved convex lens or a Fresnel lens to reduce the thickness.

The lens array 21 and the lens 22 may be two separate lenses or may be formed as a single optical member.

The display surface 10 and the lens array 21 are arranged between the focal point F of the lens 22 and the lens 22. A line connecting the focal point F of the lens 22 and a contact point B1 between the frame area 12 and the pixel area 11 intersects a lens surface outside an edge B2 of the frame area 12.

In the display system 100 having such a configuration, on each microlens 23, corresponding two pixels 13 are enlarged and viewed. Each main light beam (dashed-dotted line in FIG. 2) passing through the center of the microlens 23 is tilted toward the frame area 12. The tilted main light beam is directed to the front by the lens 22. Therefore, when observing the display surface 10 from the front, on the frame area 12, the pixels 13 seen on the microlenses 23 are observed. In other words, due to the lens 22 that covers the frame area 12, the pixels 13 seen on the lens array 21 are observed, while the frame area 12 is hardly observed by the user.

The lens array 21 is provided between the focal point F of the lens 22 and the lens 22, and thus, an enlarged image surface S of exit pupil of the lens array 21 is formed as a virtual image. The position where the virtual image S is formed is a position moved backward from the lens array 21 toward the focal point F of the lens 22. In this way, the image surface S of exit pupil of the lens array 21 is formed at a position close to the display surface 10.

Therefore, it is possible to form the image surface S of exit pupil of the lens array 21 substantially on the display surface 10 by appropriately designing the optical device 20. Thereby, also in the area in which the optical device 20 is provided, the pixels 13 seen on the exit pupil surface of lens array 21 are observed as if the pixels were on the display surface 10, and thus, a high quality image with little shift of the image surface is observed.

As described above, it is possible to prevent the image quality from being degraded due to the shift of the image surface and make the frame area 12 difficult to be seen by providing the optical device 20 including the lens array 21 and the lens 22.

Next, in FIG. 2, a range in which the image displayed in the pixel area 11 is normally viewed (hereinafter referred to as a viewing area) will be described. When two pixels 13 correspond to one microlens 23 of the lens array 21, an image surface S′, which is a two times enlarged image of the two pixels 13 (actually, greater than two times because the pitch of the microlenses 23 is somewhat greater than the pitch of pairs of pixels), is formed rearward of the display surface 10 as a virtual image. Among the image surface S′ of the enlarged two pixels, the image surface S′ corresponding to the central one pixel is located at the rear of the corresponding microlens 23 and the image surface S′ corresponding to each 0.5 pixel at the left and right ends is hidden by the microlens 23. This image surface S′ is observed through an opening of each microlens 23.

At this time, an area of an angle 2θ in which corresponding two pixels are observed through an opening of a certain microlens 23 is the viewing area. In other words, not only the front of the display surface 10, but also ranges from which the image surface of the pixels hidden by the microlens 23 can be seen are the viewing areas, and the image can be observed without a feeling of strangeness. From an area of an angle exceeding the viewing area, in the opening of the microlens 23, an image surface of an adjacent pixel, which does not correspond to the microlens 23, is observed. As a result, abnormal image is observed.

By the way, a corresponding pixel 13 is enlarged by each microlens 23. Therefore, depending on the arrangement of the microlenses 23, in a direction in which the sub-pixels are divided, moire of an enlarged image may be observed. To suppress the moire, for example, a ridge line of the microlens 23 may be arranged oblique to a boundary line which divides the sub-pixels. Thereby, resolution of color can be arranged in a direction in which the sub-pixels are not divided.

Or, an integer number of pixels 13 (for example, as shown in FIG. 2, two pixels) are enlarged as a basic unit and the enlarged pixel 13 may include all the sub-pixels. Hereinafter, a design example of the optical device 20 formed by this manner will be described.

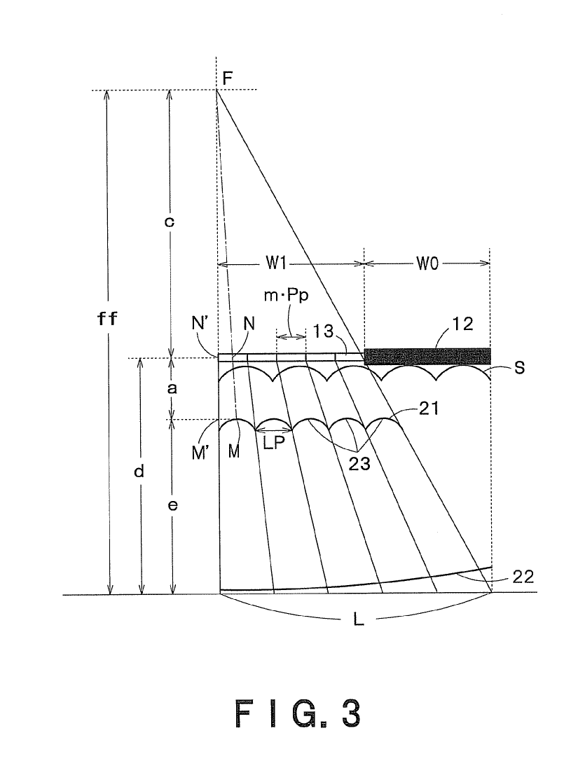

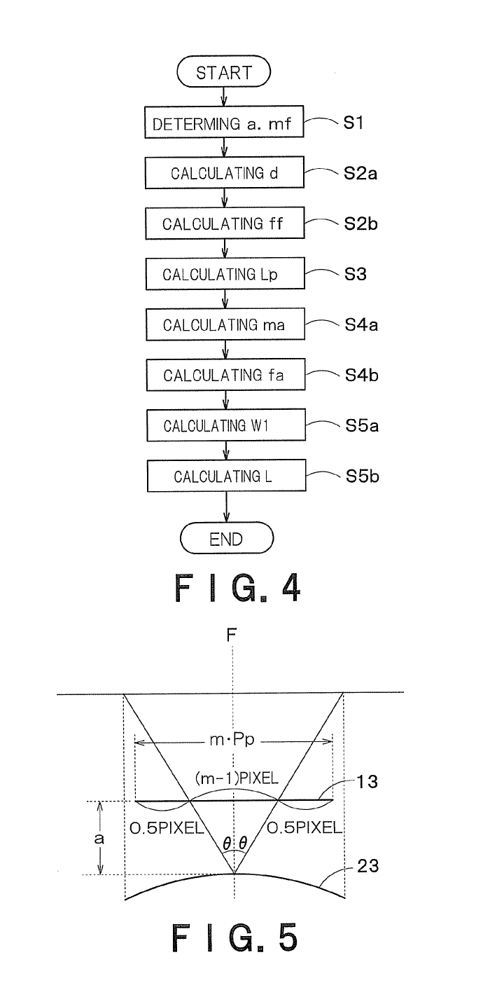

FIG. 3 is a diagram for explaining a design manner of the optical device 20. FIG. 4 is a flowchart showing an example of a design procedure of the optical device 20. In FIGS. 3 and 4, it is assumed that the position of the viewer is sufficiently far from the display surface 10. Predetermined values in FIG. 3 are the width W0 of the frame area 12, the number of pixels 13 “m” corresponding to one microlens 23 (m is a positive integer), and the pixel pitch Pp.

First, as a prerequisite, the distance “a” between the lens array 21 and the display surface 10 and the magnifying power mf of the lens 22 are determined in advance (step S1).

Subsequently, the condition of the lens 22 (more specifically, the distance “d” between the lens 22, and the display surface 10 and the focal length ff of the lens 22) is calculated from the distance “a” and the magnifying power mf in the manner as described below.

The distance between the lens array 21 and the lens 22 is defined as “e”. Since the image surface S of exit pupil of the lens array 21 is formed on the display surface 10, the formula (1) below is established.

d−e=a (1)

Further, for the magnifying power mf, the formula (2) below is established.

mf=d/e (2)

The distance “d” is determined by the formula (3) below by removing the distance “e” from the formulas (1) and (2) (step S2a).

d=a/(mf−1) (3)

On the other hand, the formula (4) below is established for a relationship among the focal length ff of the lens 22, the distance “e” between the lens array 21 and the lens 22, and the distance “d” between the lens 22 and the image surface S of exit pupil of the lens array 21.

1/ff=1/d−1/e (4)

Therefore, the focal length ff of the lens 22 is determined by the formula (5) below (step S2b).

ff=e·d/(e−d) (5)

The condition of the lens 22 is determined in the manner as described above. In other words, it is found that the lens 22 of the focal length ff represented by the above formula (5) may be arranged at the distance “d” represented by the above formula (3).

Subsequently, the lens pitch Lp of the lens array 21 is calculated in the manner as described below.

The distance between the display surface 10 and the focal point F is defined as “c”. Here, c=ff−d, so the distance “c” is a known value obtained from the above formulas (3) and (5). The lens pitch Lp of the lens array 21 is designed so that lines passing through the center M of one microlens 23 and the centers N of “m” pixels 13 corresponding to the one microlens 23 converge to the focal point F. In other words, the lens pitch Lp is designed so that the focal point F, the center M of the microlens 23, and the center N of “m” pixels 13 are located on the same straight line.

When M′ and N′ are defined as shown in FIG. 3, the triangle FMM′ and the triangle FNN′ are similar to each other. Therefore, the lens pitch Lp of the lens array 21 is determined by the formula (6) below (step S3).

Lp=m*Pp*(a+c)/c (6)

Subsequently, the conditions of each microlens 23 (more specifically, the magnifying power ma and the focal length fa of the microlens 23) are calculated in the manner as described below.

Since the position of the viewer is sufficiently far from the display surface, when one pixel of an image of m*Pp is observed from the opening of the microlens 23 of the lens pitch Lp, the magnifying power ma of the microlens 23 is determined by the formula (7) below (step S4a).

ma=Lp/Pp=m*(a+c)/c (7)

As known from this formula, the magnifying power ma of the microlens 23 is somewhat greater than “m”. The image surface S which is magnified ma times is formed at a position of a distance “a” from the microlens 23, so the formula (8) below is established for the focal point fa of the microlens 23.

1/fa=1/(ma*a)−1/a (8)

Therefore, the focal length fa of the microlens 23 is determined by the formula (9) below (step S4b).

fa=ma*a/(1−ma) (9)

In this way, it is found that the lens array 21 can be used which is formed by the microlenses 23 whose magnifying power is represented by the above formula (7) and whose focal length is represented by the above formula (9).

Subsequently, the width W1 of the pixel area 11 and the width L of the lens 22, which should be covered by the lens array 21, are calculated from the width W0 of the frame area 12 in the manner as described below.

The width W1 of the pixel area 11 is needed to be enlarged to the width L by the lens array 21 and the lens 22. The magnifying power mt that can be used to erase the frame area 12 is a product of the magnifying power ms by a lens shift of the lens array 21 and the magnifying power mf of the lens 22. The magnifying power mt is represented by the formula (10) below.

mt=ms*mf (10)

Here, “m” pixels having the length of m*Pp are seen on the microlens 23 of the lens pitch Lp by the lens array 21, and thus, the magnifying power ms by the lens shift is represented by the formula (11) below.

ms=Lp/(m*Pp)=ma/m (11)

Since the magnifying powers ms and mf have already been known, the magnifying power mt can be calculated from the above formulas (10) and (11). The width W1 of the pixel area 11 that should be covered by the lens array 21 is determined by the formula (12) below by using the magnifying power mt (step S5a).

W1=W0/mt (12)

Therefore, the width L of the lens 22 is determined by the formula (13) below (step S5b).

L=W0+W1=W0(1+1/mt) (13)

An integer obtained by rounding up the fractional part of the right-hand side in the above formula (12) can defined as the width W1 and an integer number of pixels may be covered by the lens 22.

In the above-described manner, it is possible to calculate appropriate design conditions of the lens array 21 and the lens 22 from the distance “a” between the lens array 21 and the display surface 10 and the magnifying power mf of the lens 22. Note that, FIG. 4 is only an example of the design procedure and needless to say that various modified examples may be considered.

At this time, each pixel 13 is enlarged ma*mf times by the lens array 21 and the lens 22. Therefore, for the pixel 13 at a position at which the optical device 20 is provided, an image reduced to 1/(ma*mf)=1/(m*mt) size, that is to say, an image reduced to 1/mt size using “m” pixels as a unit, may be displayed. Thereby, it is possible to maintain the continuity between an image in an area at which the optical device 20 is provided and an image in an area at which the optical device 20 is not provided, that is to say, the continuity between an image observed through the optical device 20 and an image observed not through the optical device 20.

FIG. 5 is a diagram for explaining the viewing area in the case in which the optical device 20 is designed by the design procedure shown in FIG. 4. Assuming that the position of the viewer is sufficiently far from the display surface 10, in FIG. 5, it is approximated that a straight line connecting the focal point F and the center of the microlens 23 is perpendicular to the microlens 23.

The distance between the microlens 23 and the display surface 10 is “a”. A range where (m−1) pixels among the “m” pixels are seen on the opening of the microlens 23 is a viewing area 2θ. Therefore, the viewing area 2θ is represented by the formula (14) below.

2θ=2*tan {(Pp*(m−1))/(2*a)} (14)

By the way, in FIGS. 3 and 4, it is assumed that the position of the viewer is sufficiently far from the display surface 10. In other words, a light beam perpendicular to the display surface 10 may be output from the lens 22. On the other hand, when the position of the viewer is limited, the focal length ff of the lens 22 calculated in step S2b may be modified to ff′ in the manner as described below.

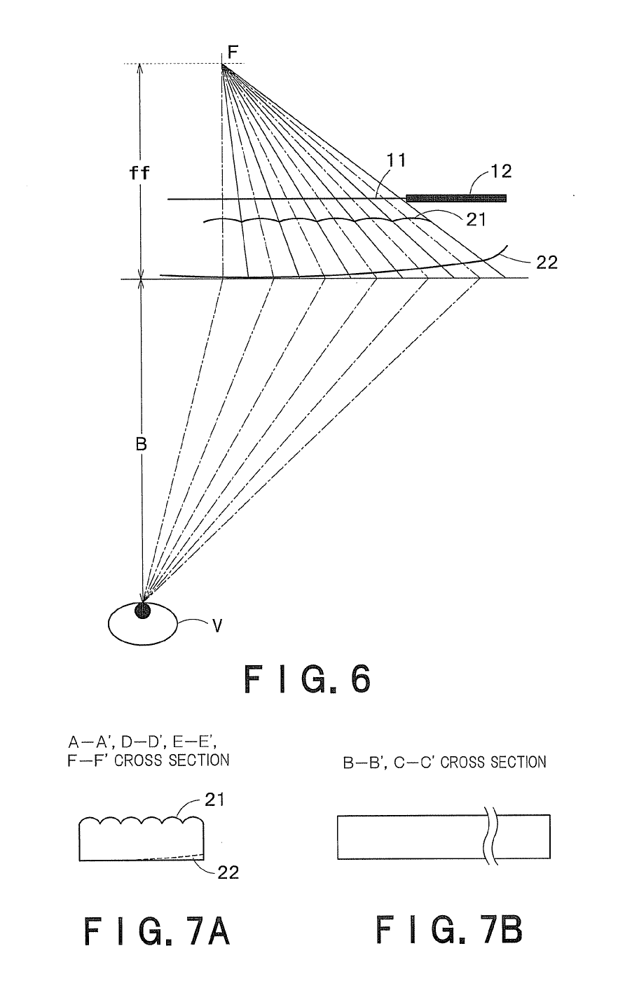

FIG. 6 is a diagram for explaining that light beams are directed to a viewer V located at a distance B away from the display surface 10. In FIG. 6, for the light beams from a distance ff away from the lens 22 to converge to one point at the distance B away from the lens 22 through the lens 22 of the focal length ff′, it is necessary to satisfy the formula (15) below.

1/ff′=1/B−1/ff (15)

Therefore, the lens 22 having the focal length ff′ represented by the formula (16) below can be used.

ff′=(ff−B)/B*ff (16)

As another manner for directing light beams to the viewer V located at the position the distance B away from the display surface 10, another lens having a focal length of the distance B may be further provided. It is possible to direct the light output from the lens 22 in FIG. 3 to the viewer V by this lens.

Next, the shape of the optical device 20 will be described in more detail. In FIG. 1, the optical device 20 arranged at the four sides of the display surface 10 and the optical device 20 arranged at the four corners are somewhat different from each other.

FIGS. 7A and 7B are diagrams schematically showing a cross-sectional shape of each optical device 20. FIGS. 7A and 7B show an example in which the lens array 21 and the lens 22 are integrally formed.

In the optical device 20 arranged at a side of the display surface 10, the optical axes of the lens array 21 and the lens 22 are in parallel with the side. In other words, the optical device 20 has one-dimensional optical power and enlarges the pixel 13 in the one-dimensional direction. More specifically, the optical device 20 arranged at a vertical side enlarges the pixel in the horizontal direction, and the optical device 20 arranged at a horizontal side enlarges the pixel in the vertical direction.

Therefore, the A-A′ and the D-D′ cross-sectional views in a direction in which the pixel 13 is enlarged are as shown in FIG. 7A. Specifically, the lens array 21 is formed by an array device of cylindrical lenses called a lenticular lens, and the lens 22 is also formed by a linear lens (cylindrical lens). As the lens 22, a normal curved surface lens (indicated by the dashed line in FIG. 7A) may be used or a Fresnel lens (as shown by a solid line in FIG. 7A, when the division of the Fresnel lens is very small, it is difficult to draw a cross section having curvature of a lens) may be used to thin the optical device 20.

In contrast, as shown in FIG. 7B, the optical device 20 is flat with regard to a direction of B-B′ and the C-C′ cross-sections, the pixel 13 not being enlarged for this direction.

On the other hand, in the optical device 20 arranged at a corner, the optical axes of the lens array 21 and the lens 22 are a corner portion of the optical device 20. In other words, the optical device 20 has two-dimensional optical power and enlarges the pixel 13 in the two-dimensional direction. More specifically, the optical device 20 enlarges the pixel 13 in the horizontal direction and the vertical direction.

Therefore, the E-E′ and the F-F′ cross-sectional views are also as shown in FIG. 7A. Specifically, the lens array 21 is formed by an array device of circular lenses called a microlens array and the lens 22 is also formed by a circular lens. The lens 22 may also be a normal curved lens or a Fresnel lens.

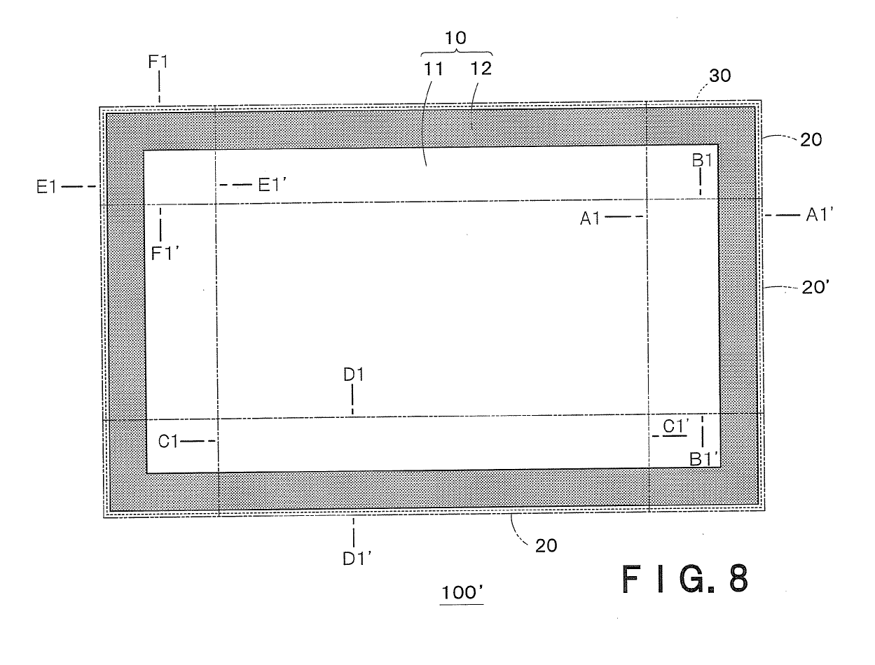

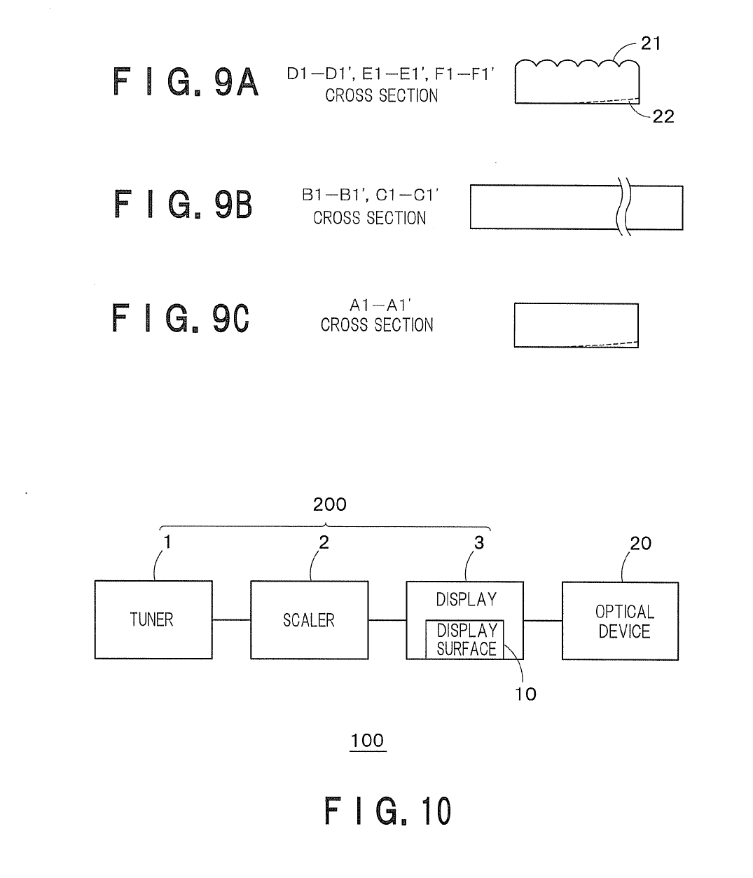

Next, a case in which the display system performs autostereoscopic display will be described. FIG. 8 is a front view of a display system 100′ that performs autostereoscopic display. FIGS. 9A to 9C are diagrams schematically showing a cross-sectional shape of each optical device 20 and 20′. When the autostereoscopic display is performed, for example, a lenticular lens 30 for controlling the depth is provided to face the display surface 10 and the depth in the horizontal direction can be controlled by the lenticular lens 30. Therefore, the optical device 20 may enlarge the pixel 13 only in the vertical direction.

Thus, the optical devices 20 provided at the horizontal sides and the corners are the same as those shown in FIGS. 7A and 7B, so that the D1-D1′, the E1-E1′, and the F1-F1′ cross-sectional views are as shown in FIG. 9A and the C1-C1′ cross-sectional view is as shown in FIG. 9B.

On the other hand, the optical devices 20′ arranged at the vertical sides do not need the lens array 21 for enlarging the pixel 13 in the horizontal direction, and a single layer linear lens may be provided as the lens 22. Therefore, the A1-A1′ cross-sectional view is as shown in FIG. 9C and the B1-B1′ cross-sectional view is as shown in FIG. 9B.

FIG. 10 is a schematic block diagram showing an entire configuration of the display system 100. The display system 100 includes a display apparatus 200 and the optical devices 20. The display apparatus 200 includes a tuner 1, a scaler 2, and a display 3 including the display surface 10.

The tuner 1 receives terrestrial broadcast waves and/or satellite broadcast waves and generates an image to be displayed by each pixel 13. The scaler 2 reduces the generated image which is displayed by the pixels 13 in an area in which the optical devices 20 are provided (more specifically, reduces the image to 1/(ma*mf) size as described above). In the pixel area 11 of the display surface 10, the reduced image is displayed by the pixels 13 in the area in which the optical devices 20 are provided and an image which is not reduced is displayed by the pixels 13 in an area in which the optical device 20 is not provided. Thereby, it is possible to display continuous images in the area in which the optical devices 20 are provided and the area in which the optical device 20 is not provided.

Although FIG. 10 shows an example in which an image signal is generated from a broadcast wave, an image signal recorded in a recording medium such as a hard disk may be displayed.

In this way, in the present embodiment, the optical devices 20 including the lens array 21 and the lens 22 are provided to face the display surface 10. Therefore, the image surface S of exit pupil of the lens array 21 on which the pixels 13 are seen is formed on substantially the same plane as that of the pixels 13. As a result, it is possible to make the frame area 12 difficult to be seen while displaying a high quality image in which the shift of the image surfaces is suppressed.

When the present embodiment is applied to one display apparatus 200, an image with a sense of presence can be displayed because the frame area 12 is not seen.

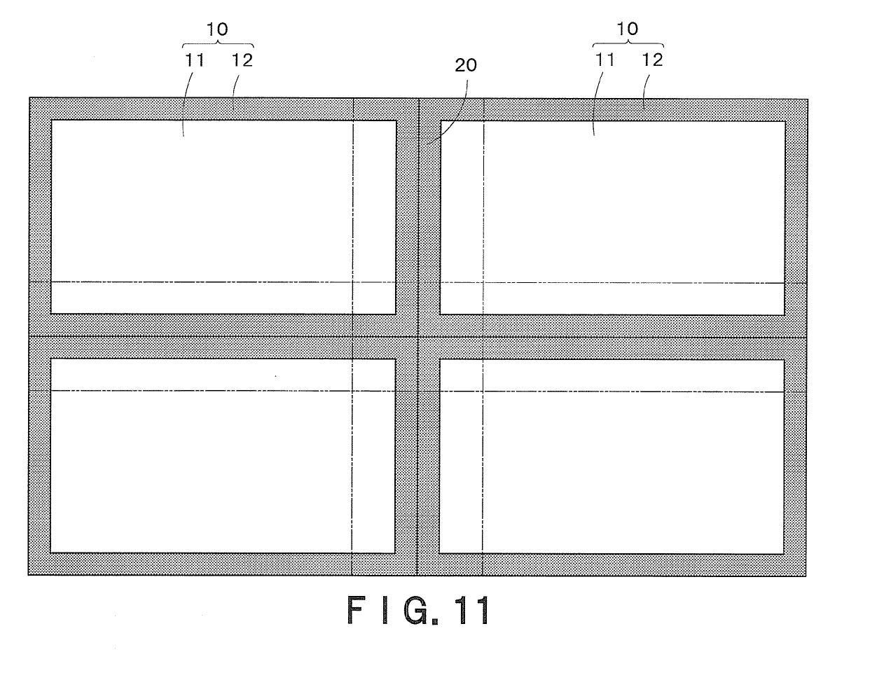

Further, as shown in FIG. 11, the present embodiment can be applied to a case in which a plurality of display apparatuses 200 is arranged in a tiled pattern. In this case, the display system includes a plurality of display apparatuses 200 and a plurality of optical devices 20. As shown in FIG. 11, when a plurality of (for example, two rows and two columns of) display apparatuses 200 are arranged, an image is divided by the frame areas 12 located between the display surfaces 10.

Therefore, the optical device 20 is provided at the frame area 12 disposed between one display surface 10 and another display surface 10 adjacent to the one display surface 10. More specifically, the lenses 22 are provided to face the frame area 12 of the one display surface 10 and a frame area of the other display surface 10 adjacent to the frame area 12.

Thereby, the frame areas 12 located between the display apparatuses 200 are not observed, and thus, the plurality of display apparatuses 200 can be seen as if the display apparatuses 200 were a single large display.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An optical device for a display apparatus comprising a display surface comprising a pixel area comprising groups of pixels, and a frame area that surrounds the pixel area, the optical device comprising:
a lens array facing the groups of pixels adjacent to at least a first part of the frame area; and
a lens facing at least a second part of the frame area and the groups of pixels adjacent to the lens array.

2. The optical device of claim 1, wherein the lens array and the lens are configured to form an image surface of exit pupil of the lens array substantially on the display surface by the lens.

3. The optical device of claim 1, wherein the lens array and the lens are provided so that, through the lens, the pixel area is observed but the frame area is not observed.

4. The optical device of claim 1, wherein the display surface and the lens array are provided between a focal point of the lens and the lens.

5. The optical device of claim 1, wherein
the lens array comprises a plurality of microlenses,
each of the plurality of microlenses corresponds to each of the groups of pixels, and
the lens array is provided so that a focal point of the lens, a center of one microlens, and a center of a group of pixels corresponding to the one microlens are on the same straight line.

6. The optical device of claim 5, wherein
when the optical device is provided to the frame area in a horizontal direction, each of the microlenses enlarges corresponding pixels in a vertical direction,
when the optical device is provided to the frame area in the vertical direction, each of the microlenses enlarges corresponding pixels in the horizontal direction, and
when the optical device is provided to a corner of the frame area, each of the microlenses enlarges corresponding pixels in the horizontal direction and the vertical direction.

7. A display system comprising:
a display surface comprising a pixel area comprising groups of pixels and a frame area that surrounds the pixel area;
a lens array facing the groups of pixels adjacent to at least a first part of the frame area; and
a lens facing at least a second part of the frame area and the groups of pixels adjacent to the lens array.

8. The display system of claim 7 further comprising a scaler configured to reduce an image displayed in a pixel area facing the lens array according to magnifying powers of the lens array and the lens.

9. The display system of claim 7 further comprising a plurality of display surfaces,
wherein the lenses are provided to face a first frame area of one of the display surfaces and a second frame area of another of the display surfaces adjacent to the first frame area.

10. The display system of claim 7 further comprising a tuner configured to receive a broadcast wave and generate an image displayed in the pixel area.
